(19) United States
(12) Patent Application Publication
(10) Pub. No.: US 2013/0134784 A1
(43) Pub. Date: May 30, 2013

(54) Ping-Pong Type Battery Management system

(71) Applicants: Lan-Rong Dung, Hsinchu City (TW); Chau-Chung Song, Chiayi City (TW); Fa-Hwa Shieh, Taoyuan County (TW); Shiang-Fu Yuan, Hsinchu City (TW); Chan-Chia Yeh, Hsinchu City (TW); Chee-Chang Chen, Taoyuan County (TW)

(72) Inventors: Lan-Rong Dung, Hsinchu City (TW); Chau-Chung Song, Chiayi City (TW); Fa-Hwa Shieh, Taoyuan County (TW); Shiang-Fu Yuan, Hsinchu City (TW); Chan-Chia Yeh, Hsinchu City (TW); Chee-Chang Chen, Taoyuan County (TW)

(73) Assignee: Chung-Shan Institute of Science and Technology, Armaments, Bureau, Ministry of National Defense, Taoyuan County (TW)

(21) Appl. No.: 13/304,736

(22) Filed: Nov. 28, 2011

(51) Int. Cl. H02J 7/34

(52) U.S. Cl. 307/43

(57) ABSTRACT

Disclosed is an Ping-Pong Type Battery Management system. The Ping-Pong Type Battery Management system includes first and second battery packs, first and second battery switches, a sensing and controlling module, a supply power regulation module and a load power regulation module. The first battery switch is formed on the first battery pack. The second battery switch is formed on the second battery pack. The sensing and controlling module is connected to the first and second battery packs and the first and second battery switches. The supply power regulation module is connected to the first and second battery switches. The load power regulation module is connected to the first and second battery switches.

### BACKGROUND OF INVENTION

1. Field of Invention

The present invention relates to a battery pack and, more particularly, to an Ping-Pong Type Battery Management system including two battery packs.

2. Related Prior Art

A conventional power storage system includes a single battery pack, and this configuration could lead to misuse of the battery pack. For example, if the state of charge (“SOC”) is kept high for a long period of time, or if the battery pack continues to discharge when the SOC is low, the life of the battery pack would considerably be reduced, and the security of the battery pack would be jeopardized. For example, if the SOC of a Li—H battery is always full, crystals would occur in the Li—H battery and reduce the useful capacity of the Li—H battery. It is generally recommended that the SOC of the Li—H battery is kept at 50% to maximize the life of the Li—H battery.

Referring to FIGS. 5 and 6, shown is a battery management system 10 for a single battery pack. In the battery management system 10, a supply power regulation module 21 is connected to a battery pack 31, and the battery pack 31 is connected to a load power regulation module 22.

In use, the supply power regulation module 21 is connected to a power supply 50 while the load power regulation module 22 is connected to a load 60. The power supply 50 may be the grid equipped with a converter or a DC power supply such as a fuel cell, a solar cell or a wind turbine equipped with a DC/DC converter for maximizing the power. The power supply 50 is used as a primary power supply to provide a power supply current 71 via the supply power regulation module 21 while the battery pack 31 is used as an auxiliary power supply as the difference between the power supply current 71 and a load current 73 required by the load power regulation module 22 is a recharge/discharge current 72 for the battery pack 31. When the power supply current 71 is larger than the load current 73, the battery pack 31 is recharged with the recharge/discharge current 72. The recharge/discharge current 72 would however be too large for the battery pack 31. There is little management of the recharge of the battery pack 31 so that the recharge is inefficient and could be harmful for the battery pack 31. When the load current 73 is larger than the power supply current 71, the battery pack 31 discharges the recharge/discharge current 72.

The conventional battery management system is simple but could cause damages of the battery pack such as reducing the efficiency of the recharge and reducing the life of the battery pack for keeping the SOC high or low for a long period of time.

The present invention is therefore intended to obviate or at least alleviate the problems encountered in prior art.

### SUMMARY OF INVENTION

It is the primary objective of the present invention to provide an efficient, reliable Ping-Pong Type Battery Management system.

To achieve the foregoing objective, the Ping-Pong Type Battery Management system includes first and second battery packs, first and second battery switches, a sensing and controlling module, a supply power regulation module and a load power regulation module. The first battery switch is formed on the first battery pack. The second battery switch is formed on the second battery pack. The sensing and controlling module is connected to the first and second battery packs and the first and second battery switches. The supply power regulation module is connected to the first and second battery switches. The load power regulation module is connected to the first and second battery switches.

In an aspect, the supply power regulation module may be a power regulator or a DC/DC converter.

In another aspect, the first and second battery packs are rechargeable batteries.

In another aspect, the supply power regulation module can be connected to an external power supply.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of an Ping-Pong Type Battery Management system according to the preferred embodiment of the present invention;

FIG. 2 is a block diagram of the Ping-Pong Type Battery Management system shown in FIG. 1 in a recharging mode;

FIG. 3 is a block diagram of the Ping-Pong Type Battery Management system shown in FIG. 1 in a discharging mode;

FIG. 4 is a table of stages of the operation of the Ping-Pong Type Battery Management system shown in FIG. 1;

FIG. 5 is a block diagram of a conventional battery management system in a recharging mode; and

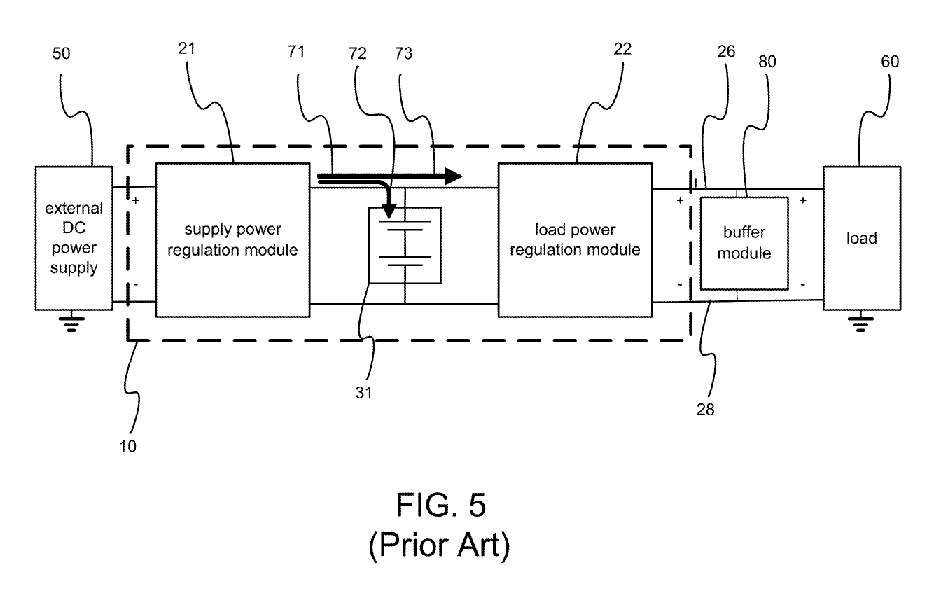

FIG. 6 is a block diagram of the conventional battery management system in a discharging mode.

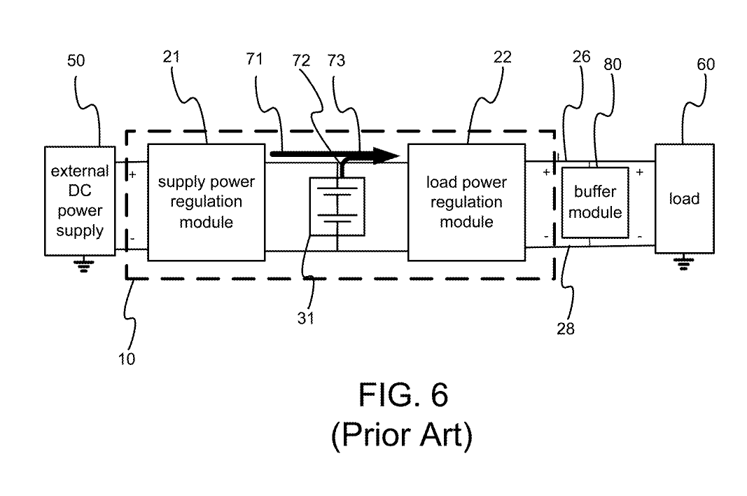

### DETAILED DESCRIPTION OF PREFERRED EMBODIMENT

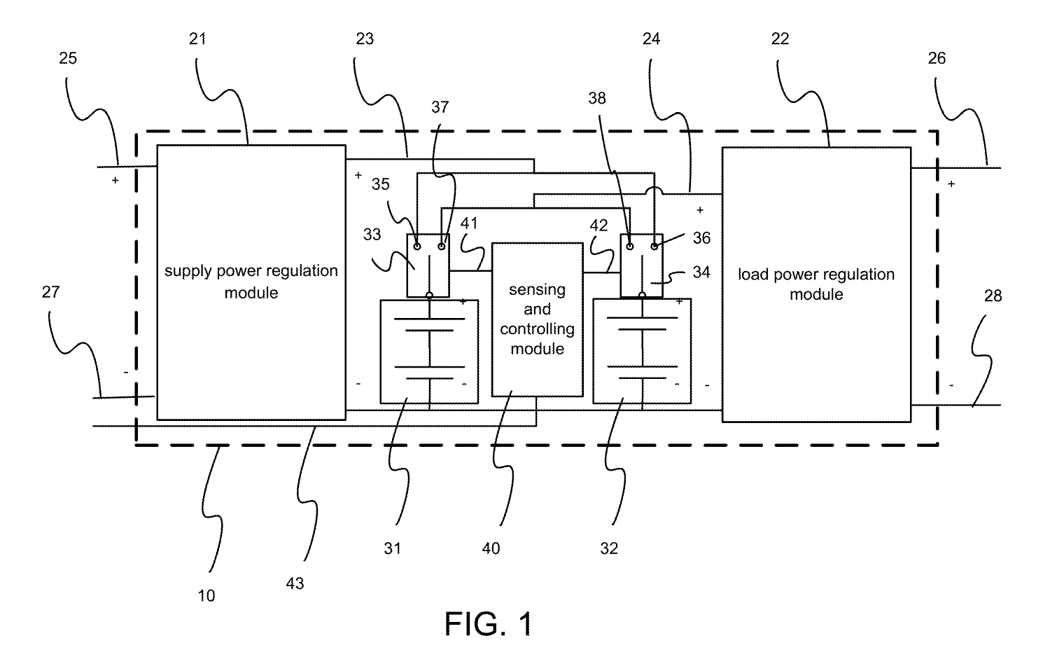

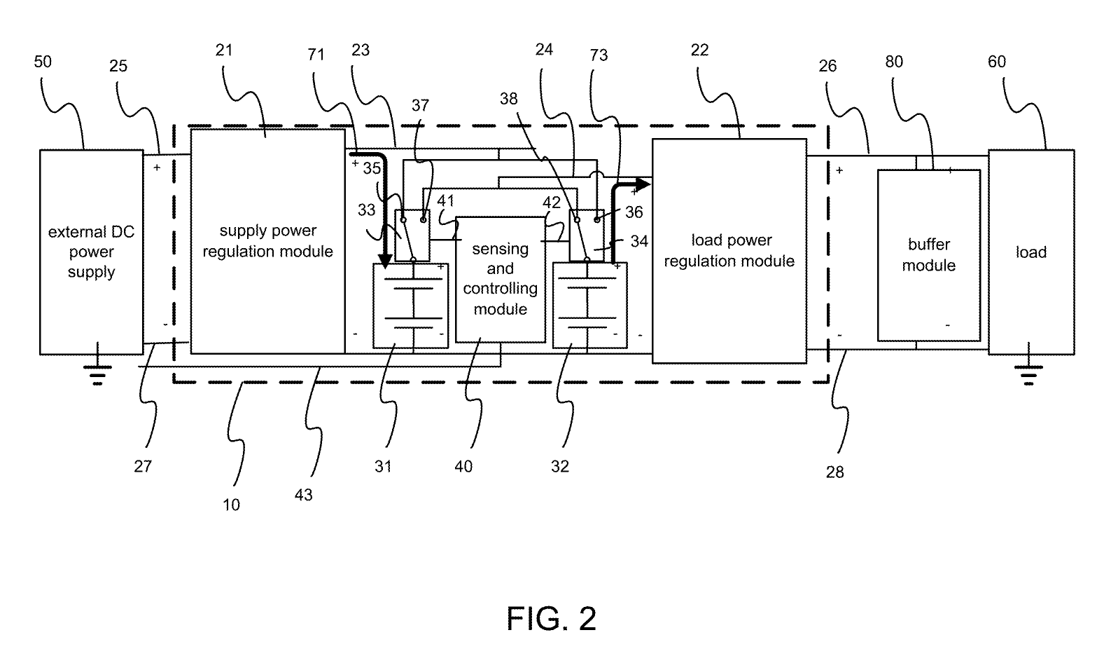

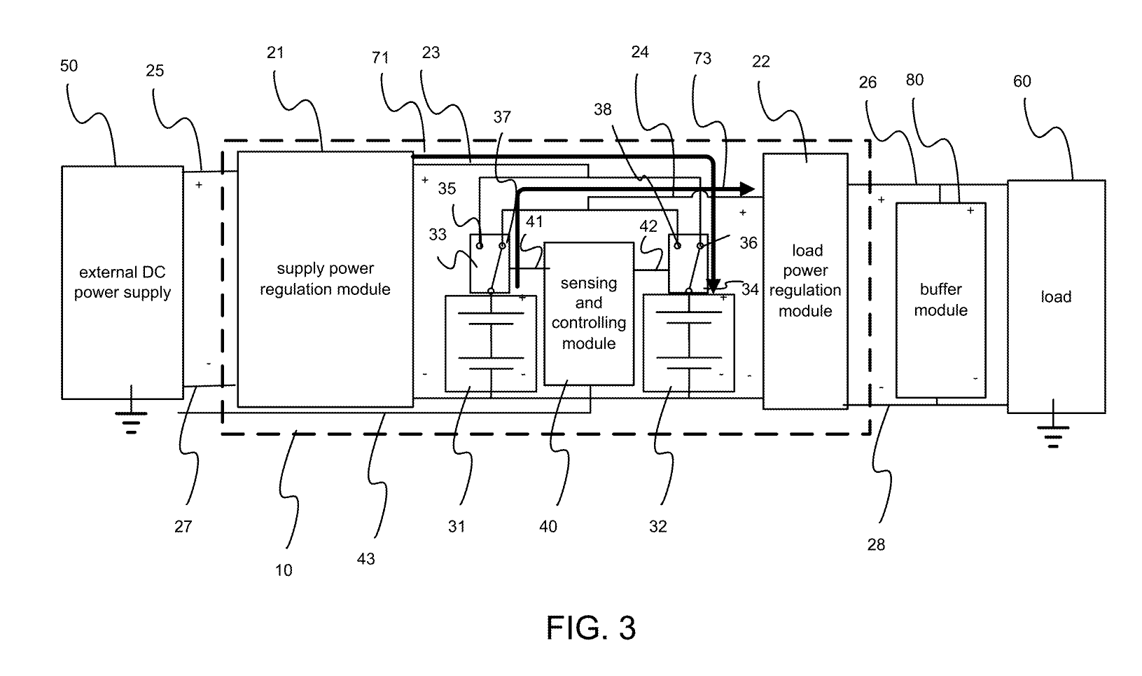

Referring to FIG. 1, shown is an Ping-Pong Type Battery Management system 10 according to the preferred embodiment of the present invention. The Ping-Pong Type Battery Management system 10 includes two battery packs 31 and 32, two battery switches 33 and 34, a sensing and controlling module 40, a supply power regulation module 21 and a load power regulation module 22. The first battery switch 33 is provided on the first battery pack 31 while the second battery switch 34 is provided on the second battery pack 32. The sensing and controlling module 40 is connected to the battery packs 31 and 32 and the battery switches 33 and 34 and used to sense the state of the battery packs 31 and 32 and control the operation of the battery switches 33 and 34. The supply power regulation module 21 is connected to the battery switches 33 and 34 and used to regulate an external DC power supply 50 (FIGS. 2 and 3). The load power regulation module 22 is connected to the battery switches 33 and 34. The load power regulation module 22 is used to regulate a load 60 (FIGS. 2 and 3).

The supply power regulation module 21 may be a power regulator or a DC/DC converter.

An input end of the supply power regulation module 21 is connected to the external DC power supply 50 via a high-potential wire 25 and a low-potential wire 27. The external DC power supply 50 may be a combination of the grid with an AC/DC converter or a combination of a DC power supply such as a fuel cell, a wind turbine or a solar cell with a DC/DC converter.

The supply power regulation module 21 is used to turn the external DC power supply 50 into a DC power supply suitable for the first battery packs 31 and 32.

An output end of the supply power regulation module 21 is connected to recharge ends 35 and 36 of the battery switches 33 and 34 via a high-potential wire, i.e., a recharge wire 23. The output end of the supply power regulation module 21 is connected to low-potential ends of the battery packs 31 and 32 via a low-potential wire.

An input end of the load power regulation module 22 is connected to discharge ends 37 and 38 of the battery switches 33 and 34 via a high-potential wire, i.e., a discharge wire 24. The input end of the load power regulation module 22 is connected to low-potential ends of the battery packs 31 and 32 via a low-potential wire.

An output end of the load power regulation module 22 is connected to the load 60 and a buffer module 80 via a high-potential wire 26 and a low-potential wire 28. The buffer module 80 may be a super capacitor or the like.

The load power regulation module 22 may be a power regulator or a DC/DC convertor. The load power regulation module 22 is used to turn each of the battery packs 31 and 32 into a DC power supply suitable for the load 60. The buffer module 80 connected to the output end of the load power regulation module 22 may be a super capacitor to regulate the load current by avoiding radical changes in the load current during switching of the battery switches 33 and 34.

Each of the battery packs 31 and 32 may include a single rechargeable battery or several rechargeable batteries.

The positive ends (or “high-potential ends”) of the battery pack 31 and 32 are connected to the battery switch 33 and 34, respectively.

The sensing and controlling module 40 is connected to the battery packs 31 and 32 and the battery switches 33 and 34 via sensing and controlling paths 41 and 42, respectively. The sensing and controlling module 40 is used to sense the SOC of the battery packs 31 and 32 as a basis for alternate control over the switching of the battery switches 33 and 34 to recharging, discharging or open.

The sensing and controlling module 40 may be a processor, a microcontroller unit (“MCU”), a digital signal processor (“DSP”), a programmable logic controller (“PLC”), a logic circuit, a microcomputer or a computer. The sensing and controlling module 40 is used to sense the SOC of the battery packs 31 and 32 to control the switching of the battery switches 33 and 34 between recharging, discharging or open. The sensing and controlling module 40 is further used to transmit information sensed in the battery pack 31 and 32, commands, warning and trouble-related information to an apparatus located outside the Ping-Pong Type Battery Management system 10 via an external communication path 43.

The information sensed and estimated by the sensing and controlling module 40 may be the SOC, voltage, temperature, alone or in any combination, or any other information for estimating the state of the battery packs.

Preferably, the SOC is used as the basis for the switching. The sensing and controlling module 40 is used to estimate the SOC of the battery pack based on the sensed information according to Coulomb Method or the diffusion law method.

In operation, it is necessary to consider the stability of the system and the state of the battery packs 31 and 32. Hence, the following rules are made.

At first, regarding the SOC of the battery packs 31 and 32, an upper boundary is set to be 70% while a lower boundary is set to be 30%. The upper and lower boundaries are of course changeable. When the SOC of both of the battery packs 31 and 32 exceed the upper or lower boundaries, the Ping-Pong Type Battery Management system produces a warning.

For security, regarding the SOC of the battery packs 31 and 32, an upper limit is set to be 95% while a lower limit is set to be 5%. The upper and lower limits are of course changeable. When the SOC of both of the battery packs 31 and 32 exceed the upper or lower limits, the Ping-Pong Type Battery Management system protects the battery packs 31 and 32.

Secondly, when the SOC of both of the battery packs 31 and 32 reach the upper limits, i.e., the battery packs 31 and 32 are soon to be over-recharged, the Ping-Pong Type Battery Management system stops recharging and allows discharging so that the SOC of at least one of the battery packs 31 and 32 drops below the upper limit. Then, recharging is allowed again.

Thirdly, when the SOC of both of the battery packs 31 and 32 exceed the lower limit, i.e., the battery packs are about to over-discharge, the Ping-Pong Type Battery Management system stops discharging and allows recharging. The Ping-Pong Type Battery Management system so that the SOC of at least one of the battery packs 31 and 32 rises above the lower limit. Then, discharging is allowed again.

Fourthly, to prevent synchronous switching of the battery switches 33 and 34 from causing short circuit that would jeopardize the battery packs 31 and 32, switching signal time series with delay time can be used.

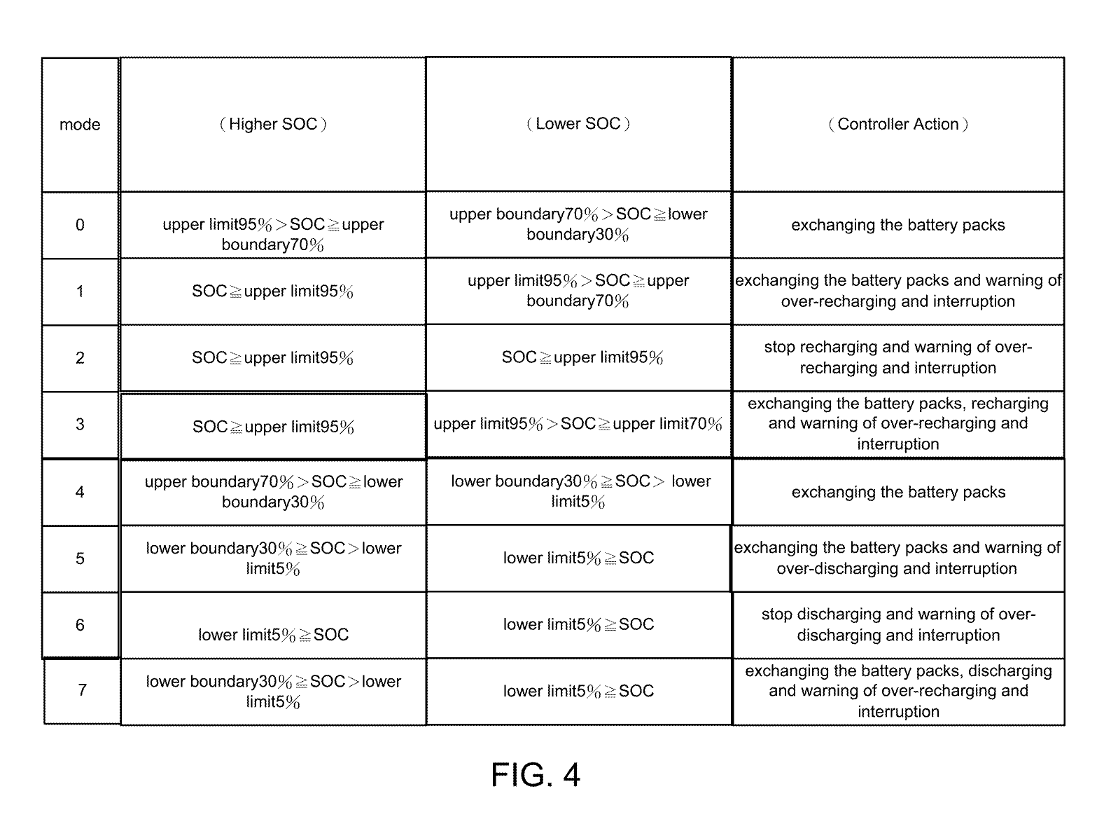

Referring to FIG. 4, the recharging and discharging are executed in eight modes. When the Ping-Pong Type Battery Management system 10 is turned on, the sensing and controlling module 40 estimates the voltages of the battery packs 31 and 32, connects the recharge wire 23 to one of battery packs 31 and 32 with the lower voltage, and connects the discharge wire 24 to the other battery pack. The battery packs 31 and 32 are exchanged once the SOC of the recharged battery pack reaches the upper boundary (Mode 0) or the SOC of the discharging battery pack reaches the lower boundary (Mode 4).

As the first battery pack 31 is switched from recharged to discharging as shown in FIGS. 2 and 3, the first battery switch 33 is switched from the recharge end 35 to the discharge end 37 while the second battery switch 34 is switched from the discharge end 38 to the charge end 36.

If the power supply current 71 continues to be much larger than the load current 73, i.e., the SOC of the discharging battery pack remains high while the SOC of the recharged battery pack is about to reach the upper limit (95%), the battery packs will be exchanged, and the sensing and controlling module 40 will send a warning of interruption via the external communication path 43 (Mode 1).

If the power supply current 71 continues to be much larger than the load current 73 and the SOC of both of the battery packs 31 and 32 reach the upper limit (95%), the recharging will stop but the discharging and the warning of interruption will continue (Mode 2). Interruption is executed via switching the recharged battery switch from the recharge end to open.

If the SOC of the discharging battery pack drops below the upper boundary (70%), the battery packs will be exchanged, recharging will then be executed again, and the warning of interruption will continue (Mode 3).

If the power supply current 71 continues to be much smaller than the load current 73 so that the recharged battery pack can hardly be recharged and the SOC of the recharged battery pack remains at the lower boundary (5%) and that the SOC of the discharging battery pack is about to reach the lower boundary, the battery packs will be exchanged, and the sensing and controlling module 40 will send a warning of interruption via the external communication path 43 (Mode 5).

If the power supply current 71 continues to be much smaller than the load current 73 and the recharge and discharge ends are about to reach the lower limit (5%), the discharging will stop but the recharging and the warning of interruption will continue (Mode 6). Interruption is executed via switching the discharging battery switch from the discharging end to open.

If the SOC of the recharged battery pack rises and reaches the lower boundary (30%), the battery packs will be exchanged, the discharging will then be executed again, and the warning of interruption will continue (Mode 7).

With the recharging and discharging of the battery packs 31 and 32 executed in these modes, the SOC of the battery packs 31 and 32 are kept between the upper and lower boundaries most of the time and would not exceed the upper and lower limits, i.e., over-recharging and over-discharging are avoided. The SOC of none of the battery packs 31 and 32 would be kept high for a long period of time.

Before the battery packs 31 and 32 are exchanged, they are switched to open synchronously to avoid short circuit that would cause the battery pack at the high voltage to recharge the battery pack at the low voltage. Based on the turning on and off of a power transistor, the switching of the battery packs 31 and 32 could be done as fast as in 50 nanoseconds. The switching of the battery packs 31 and 32 is however done in 1 microsecond in practice.

The output current from the supply power regulation module 21 via the recharge wire 23 is used for recharging the battery packs 31 and 32 only. Thus, recharge parameters can be set for the recharged battery pack to make sure that the recharging is executed efficiently and that the life of the battery packs and the stability of the system are protected from improper recharging and operation.

It is generally recommended that the SOC of each of the battery pack is kept at about 50% to maximize the life of the battery pack. By exchanging the battery packs 31 and 32 and setting the range of operation near 50%, the battery packs 31 and 32 are completely used. The life of each of the battery packs 31 and 32 is extended to protect each of the battery packs 31 and 32 from a reduced capacity or life because the SOC is too high or low.

As discussed above, the Ping-Pong Type Battery Management system divides a conventional battery pack into first and second battery packs, and uses the sensing and controlling module together with the first and second battery switches to use the supply power regulation module to recharge the battery packs only without having to supply the load current. The recharging of the battery pack is executed on a need-to-do basis. The first battery pack is recharged when the second battery pack discharges. The first battery pack discharges when the second battery pack is recharged. The battery packs take turns to be recharged and discharge. Thus, over-recharging and over-discharging are avoided.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An Ping-Pong Type Battery Management system including:
a first battery pack 31;
a first battery switch 33 formed on the first battery pack 31;
a second battery pack 32;
a second battery switch 34 formed on the second battery pack 32;
a sensing and controlling module 40 connected to the first and second battery packs 31, 32 and the first and second battery switches 33, 34;
a supply power regulation module 21 connected to the first and second battery switches 33, 34; and
a load power regulation module 22 connected to the first and second battery switches.

2. The Ping-Pong Type Battery Management system according to claim 1, wherein the supply power regulation module 21 is selected from the group consisting of a power regulator and a DC/DC converter.

3. The Ping-Pong Type Battery Management system according to claim 1, wherein the first and second battery packs 31, 32 are rechargeable batteries.

4. The Ping-Pong Type Battery Management system according to claim 1, wherein the supply power regulation module 21 can be connected to an external power supply 50.
